(19) United States
(12) Patent Application Publication
(10) Pub. No.: US 2023/0036908 A1
(43) Pub. Date: Feb. 2, 2023

(54) AUTOMOTIVE FUEL PUMP

(71) Applicant: SH Technologies Co., Ltd., Incheon (KR)

(72) Inventor: Hyun Bok KIM, Incheon (KR)

(73) Assignee: SH Technologies Co., Ltd., Incheon (KR)

(21) Appl. No.: 17/479,901

(22) Filed: Sep. 20, 2021

(30) Foreign Application Priority Data
Jul. 28, 2021 (KR) 10-2021-0099422

(51) Int. Cl. F04B 43/04

(52) U.S. Cl. CPC F04B 43/04

(57) ABSTRACT

Provided is an automotive fuel pump. An upper body includes a valve driving body configured to reciprocate up and down and including a solenoid and a reciprocating rod. A lower body includes a reservoir housing provided below the upper body in a sealing manner. The reservoir housing has a fuel intake space, a fuel discharge space, and a fuel outlet. A reservoir cup is provided on a bottom of the reservoir housing and has a fuel inlet. A diaphragm includes a thin sheet separating the reservoir housing and the upper body and is actuated by the reciprocating rod of the upper body so as to perform a pumping action. An air pocket is provided in the discharge space, and has a predetermined expansible/contractible space. Discharge performance for supplying fuel is improved, thereby improving the fuel consumption efficiency of a vehicle.

### CROSS REFERENCE TO RELATED APPLICATION

The present application claims priority to Korean Patent Application No. 10-2021-0099422, filed in the Republic of Korea on Jul. 28, 2021, which is hereby incorporated by reference for all purposes as if fully set forth herein.

### BACKGROUND

### Field

The present disclosure relates generally to an automotive fuel pump and, more particularly, to an automotive fuel pump configured to improve discharge performance for supplying fuel, thereby improving the fuel consumption efficiency of a vehicle.

### Description

In general, a fuel supply system of a vehicle includes a fuel pump module configured to draw in fuel stored in the fuel tank and supply the fuel to the engine.

For example, the fuel pump module disposed within the fuel tank of the vehicle supplies fuel in high pressure from the fuel pump to a delivery pipe of the engine, so that the injector may supply the fuel into the cylinder. A fuel filter is mounted on the fuel pump module. The fuel filter serves to remove impurities from the fuel to prevent the impurities from being delivered toward the engine, thereby preventing the fuel pump from being broken by the impurities and thus maintaining the lifetime of the fuel pump.

Such a fuel pump module is generally implemented as a mechanical diaphragm pump for an evaporative engine and as an electric motor pump for a gasoline injection engine.

Here, the electric motor pump may include an electric motor type and a solenoid type. Currently, the electric motor type is used in most cases.

The fuel pump module includes an upper plate and a reservoir cup disposed vertically inside the fuel tank, a filter disposed inside the reservoir cup, a motor for pumping fuel, and the like.

In addition, the upper plate and the reservoir cup are connected to each other through a support bar having a spring.

In addition, the filter includes an upper filter housing, a middle filter housing, and a lower filter housing configured to be fitted to each other, and includes an element disposed inside the middle filter housing. Here, the filter is configured to be disposed to be connected to the motor and the reservoir cup while be disposed concentrically between the motor and the reservoir cup.

However, in the fuel pump module having the above-described structure, vibration occurring during the operation of the fuel pump delivering a required flow rate to the engine causes severe noise while being directly transferred to the filter side. Consequently, this problem makes it difficult to obtain quality.

For example, vibration generated due to the operation of the fuel pump may be in turn transmitted to components and then introduced to the internal and external portions of the vehicle, thereby generating a droning noise. Consequently, the vibration may cause customer dissatisfaction, which is problematic.

The vibration generated due to high RPM rotation of the motor may be introduced to the cabin through the filter, the reservoir cup, the upper plate, and the fuel tank, thereby causing customer dissatisfaction, which is problematic.

In order to reduce the problem to some extent, a pad is additionally provided on top of the motor, and a pad is added to a side surface of the reservoir cup. However, the effects thereof may be insignificant. In this case, costs and the number of components may be increased due to the addition of the pads for insulation, thereby disadvantageously increasing investment cost, management cost, and the like.

In addition, due to the limited performance of the pump, it may be difficult to supply fuel in high pressure. Thus, the consumption efficiency of the fuel may be low, thereby causing degrading the performance of the engine.

The information disclosed in the Background section is only provided for a better understanding of the background and should not be taken as an acknowledgment or any form of suggestion that this information forms prior art that would already be known to a person having ordinary skill in the art.

### Related Art Document

Patent Document 1: Korean Patent No. 10-0729200 B1

### BRIEF SUMMARY

Various aspects of the present disclosure provide an automotive fuel pump configured to limit the space ratio of a reservoir housing and to improve discharge performance for supplying fuel due to a structure including an air pocket therein, thereby improving the fuel consumption efficiency of a vehicle.

According to an aspect, an automotive fuel pump may include an upper body, a lower body, a diaphragm, and an air pocket. The upper body may include a valve driving body configured to reciprocate up and down, the valve driving body including a solenoid and a reciprocating rod. The lower body may include: a reservoir housing provided below the upper body in a sealing manner, having a predetermined volume such that a fuel intake space and a fuel discharge space are defined therein, and including a fuel outlet on one side thereof; and a reservoir cup provided on a bottom of the reservoir housing and including a fuel inlet. The diaphragm may include a thin sheet separating the reservoir housing and the upper body from each other and be configured to be actuated by the reciprocating rod of the upper body so as to perform a pumping action. The air pocket may be provided in the discharge space, and have a predetermined expansible/contractible space.

The intake space defined in the reservoir housing may have a smaller volume than the discharge space. In the entire volume of the reservoir housing, the volume ratio of the intake space with respect to the discharge space may be 1:3.

The air pocket may be made from silicone, a PVC material, or a combination thereof. The automotive fuel pump may further include two check valves disposed between the intake space and the discharge space, each of the check valves including a thin sheet made from metal.

According to embodiments of the present disclosure, discharge performance for supplying fuel may be improved, thereby improving the fuel consumption efficiency of a vehicle.

### DESCRIPTION OF DRAWINGS

The above and other objectives, features, and advantages of the present disclosure will be more clearly understood from the following detailed description, taken in conjunction with the accompanying drawings, in which:

FIGS. 1 and 2 are cross-sectional views illustrating the configuration and operation state of an automotive fuel pump according to embodiments of the present disclosure; and

FIG. 3 is a plan cross-sectional view illustrating the inner shape of the reservoir housing used in the automotive fuel pump according to embodiments of the present disclosure.

### DETAILED DESCRIPTION

Hereinafter, reference will be made to embodiments of the present disclosure in detail with reference to the accompanying drawings so that a person having ordinary skill in the art to which the present disclosure relates could easily put the present disclosure into practice.

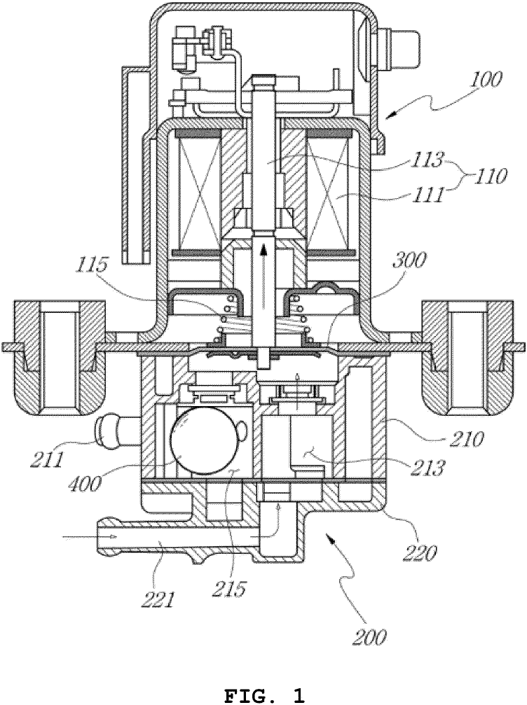

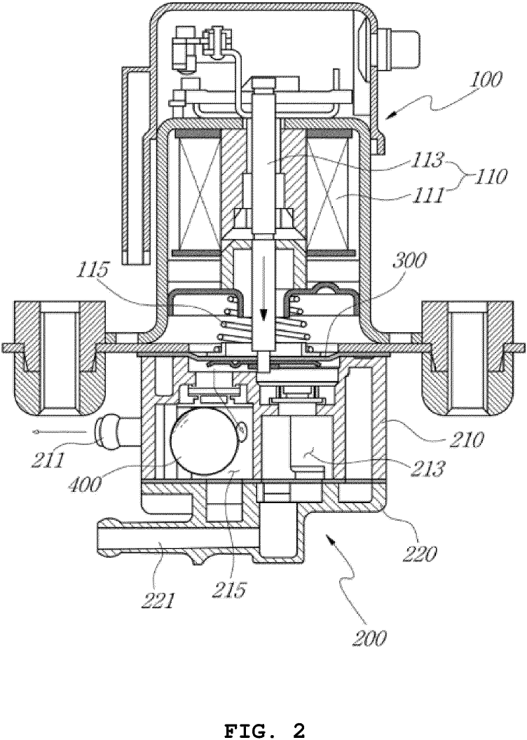

As illustrated in FIGS. 1 to 3, an automotive fuel pump according to embodiments of the present disclosure includes an upper body 100, a lower body 200, and a diaphragm 300 provided between the upper body 100 and the lower body 200 and is configured to pump fuel using the upper body 100, the lower body 200, and the diaphragm 300.

The diaphragm provides a sealing function to detect pressure or convert a pressure displacement or force. The diaphragm is categorized into a metal diaphragm and a non-metal diaphragm used for, for example, a calculating or amplifying element of a device using pneumatic pressure. The metal diaphragm is implemented as a metal plate (or disc) deformed into a corrugated shape, and is used by equaling the elasticity and pressure of the material thereof. The non-metal diaphragm is used by combining springs, the central portion of each of which is pressed with a metallic washer so as to be corrected.

A technology for coupling the above-described components to each other and performing the pumping operation using these components is well-known in the art.

The upper body 100 includes a valve driving body 110 configured to reciprocate up and down. The valve driving body 110 includes a solenoid 111 and a reciprocating rod 113.

In other words, the solenoid 111 is provided inside the upper body 100 having a predetermined space defined therein. The reciprocating rod 113 is provided at an intermediate position (or middle position) and is configured to reciprocate. The reciprocating rod 113 may be driven to reciprocate by magnetic force generated by an electrical signal supplied through wires connected to the solenoid 111. When magnetic force is generated, the reciprocating rod 113 is moved back. When the magnetic force is released, the reciprocating rod 113 is driven to move forward by restorative force of a spring 115 provided on the leading end of the solenoid 111. In this manner, the diaphragm 300 located on the leading end of the reciprocating rod 113 may be operated to enable pumping.

In addition, the lower body 200 may include a reservoir housing 210 and a reservoir cup 220. The reservoir housing 210 is provided below the upper body 100 in a sealing manner. The reservoir housing 210 is a housing having a predetermined volume such that a fuel intake space 213 and a fuel discharge space 215 are defined therein. The reservoir housing 210 also has a fuel outlet 211 on one side thereof. The reservoir cup 220 is provided on the bottom of the reservoir housing 210, and has a fuel inlet 221.

Here, the reservoir housing 210 and the reservoir cup 220 of the lower body 200 may be sequentially located and be firmly coupled to each other by fastening a plurality of bolts to fastening holes formed in the longitudinal direction. A gasket having the same size as a coupling area to which each of the reservoir housing 210 and the reservoir cup 220 is coupled may be provided so as to provide sealing force.

In addition, the diaphragm 300 is a thin sheet separating the reservoir housing 210 and the upper body 100 from each other, and may be actuated by the reciprocating rod 113 of the upper body 100 so as to perform a pumping action.

Here, an air pocket 400 having an expansible/contractible space 410 may be further provided in the discharge space 215.

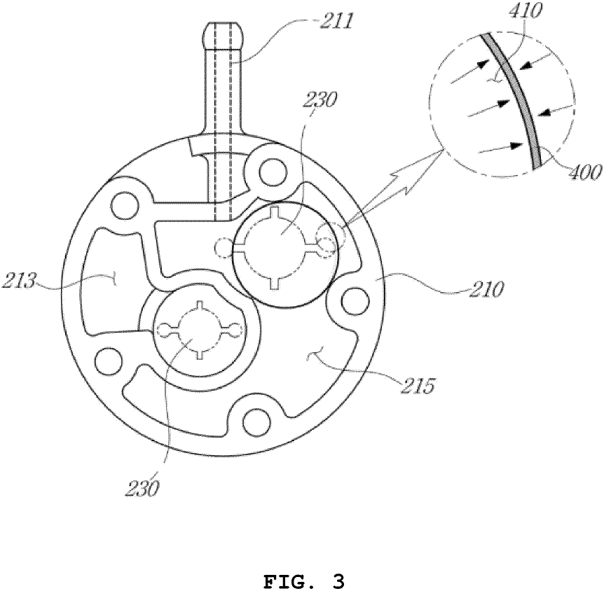

Referring to FIG. 3, a check valve 230 is provided in each of the discharge space 215 and the intake space 213 of the reservoir housing 210. When fuel is drawn into the intake space 213 in response to the operation of the diaphragm 300, the diaphragm 300 moves back so that fuel enters the pumping space due to pumping through the check valve 230. In contrast, when the diaphragm 300 moves forward, fuel located in the pumping space is caused to move to the discharge space 215 due to pumping through the check valve 230. In this case, due to the elastic force of the air pocket 400 provided in the discharge space 215, the extraction pressure of fuel discharged through the outlet 211 from the discharge space 215 may be maximized.

In addition, the volume of the intake space 213 defined in the reservoir housing 210 may be smaller than the volume of the discharge space 215.

More specifically, in the entire volume of the reservoir housing 210, the volume ratio of the intake space 213 with respect to the discharge space 215 may be 1:3.

Thus, due to the volume ratio as above, the discharge pressure of fuel discharged through the outlet 211 may be increased to the range of from 460 Pa to 500 Pa.

The air pocket 400 may comprise silicone, a PVC material, or a combination thereof. Two check valves 230 respectively implemented as a thin sheet made from metal may be provided between the intake space 213 and the discharge space 215.

According to the present disclosure as set forth above, discharge performance for supplying fuel may be improved, thereby improving the fuel consumption efficiency of a vehicle.

The terms and words used in the specification and the appended claims should not be interpreted as having ordinary or dictionary meanings, but as meanings and concepts conforming to the technical spirit of the present disclosure, based on the principle that an inventor may properly define the concept of the terms at his/her own discretion in order to describe the invention in the best manner possible.

Therefore, since the exemplary embodiments described herein and the configurations illustrated in drawings are merely the most preferred embodiments of the present disclosure and are not intended to limit all the technical concepts of the present disclosure, it should be understood that there may be variations, equivalents or modifications capable of replacing them at the time of filing of this application.

What is claimed is:

1. An automotive fuel pump comprising:
an upper body comprising a valve driving body configured to reciprocate up and down, the valve driving body comprising a solenoid and a reciprocating rod;
a lower body comprising:
a reservoir housing provided below the upper body in a sealing manner, having a predetermined volume such that a fuel intake space and a fuel discharge space are defined therein, and comprising a fuel outlet on one side thereof; and
a reservoir cup provided on a bottom of the reservoir housing and comprising a fuel inlet;
a diaphragm comprising a thin sheet separating the reservoir housing and the upper body from each other, and configured to be actuated by the reciprocating rod of the upper body so as to perform a pumping action; and
an air pocket provided in the discharge space and having a predetermined expansible/contractible space.

2. The automotive fuel pump according to claim 1, wherein the intake space defined in the reservoir housing has a smaller volume than the discharge space.

3. The automotive fuel pump according to claim 2, wherein, in an entire volume of the reservoir housing, the volume ratio of the intake space with respect to the discharge space is 1:3.

4. The automotive fuel pump according to claim 1, wherein the air pocket comprises silicone, a PVC material, or a combination thereof.

5. The automotive fuel pump according to claim 1, further comprising two check valves disposed between the intake space and the discharge space, each of the check valves comprising a thin sheet made from metal.
